(19) United States
(12) Patent Application Publication
(10) Pub. No.: US 2002/0000206 A1
(43) Pub. Date: Jan. 3, 2002

(54) Pet sheet

(76) Inventors: Takeshi Ikegami, Tokyo (JP); Kengo Ochi, Tokyo (JP)

Correspondence Address: BAKER & DANIELS, 111 E. WAYNE STREET, SUITE 800, FORT WAYNE, IN, 46802

(21) Appl. No.: 09/888,933

(22) Filed: Jun. 25, 2001

(30) Foreign Application Priority Data
Jun. 29, 2000 (JP) 2000-196949

(51) Int. Cl. A01K 29/00

(52) U.S. Cl. 119/161

(57) ABSTRACT

A pet sheet includes an absorbent material having a good liquid-absorbing property; a hydrophilic top sheet provided on the absorbent material; and an acidic polymer solution which is added to the absorbent material and the top sheet.

### CROSS REFERENCE TO RELATED APPLICATION

This application claims the priority of Application No. 2000-196949, filed Jun. 29, 2000 in Japan, the subject matter of which is incorporated herein by reference.

### TECHNICAL FIELD OF THE INVENTION

The present invention relates to a pet sheet for use in the treatment of excrements of house pets in the manner where the pet sheet is laid on the floor or the like.

### BACKGROUND OF THE INVENTION

A pet sheet includes, for example, a top sheet which absorbs a liquid material, a water-repellent (water-proofing) back sheet and an absorbent material (article) provided between the top and back sheets. Urine discharged from a pet animal is absorbed in the absorbent material through the top sheet.

In the conventional pet sheet using an absorbent material made of pulp (tissue paper) or a polymer and a top sheet made of a non-woven fabric provided on the absorbent material, urine discharged from a pet is diffused in the pulp layer through the top sheet upon urination. As a result, the urine remains on the pulp, tissue paper or non-woven fabric, causing a problem of spreading uncomfortable urinous odors in the room.

### OBJECTS OF THE INVENTION

Accordingly, an object of the present invention is to provide a pet sheet which can absorb pet urine quickly and eliminate the odors generated from the urine.

Another object of the present invention is to provide a pet sheet which has an improved urine-absorbing efficiency.

Additional objects, advantages and novel features of the present invention will be set forth in part in the description that follows, and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

According to a first aspect of the present invention, a pet sheet includes an absorbent material having a good liquid-absorbing property; a hydrophilic top sheet provided on the absorbent material; and an acidic polymer solution which is added to the absorbent material and the top sheet.

According to a second aspect of the present invention, a pet sheet includes an absorbent material having a good liquid-absorbing property; a hydrophilic top sheet provided on the absorbent material; and a solution of an amphoteric polymer having an acid pH being added to the absorbent material and the top sheet.

### BRIEF DESCRIPTION OF THE DRAWINGS

FIG. 1 is a plan view of a pet sheet according to an embodiment of the present invention.

FIG. 2 is a partially sectional view taken along line A-A′ of FIG. 1.

### DETAILED DISCLOSURE OF THE INVENTION

In the following detailed description of the preferred embodiments, reference is made to the accompanying drawings which forma part hereof, and in which is shown by way of illustration specific preferred embodiments in which the inventions may be practiced. These embodiments are described in sufficient detail to enable those skilled in the art to practice the invention, and it is to be understood that other embodiments may be utilized and that logical, mechanical and electrical changes may be made without departing from the spirit and scope of the present inventions. The following detailed description is, therefore, not to be taken in a limiting sense, and scope of the present inventions is defined only by the appended claims.

Hereinafter, an embodiment of the present invention will be illustrated in which a rectangular pet sheet is produced, by way of example. Although, in the present invention, the shape, size, etc. of the pet sheet are limited to those specified in the embodiment, those specifications or characteristics may vary depending on the types of the pets to be treated, circumstances where the pet sheet is used, and so on.

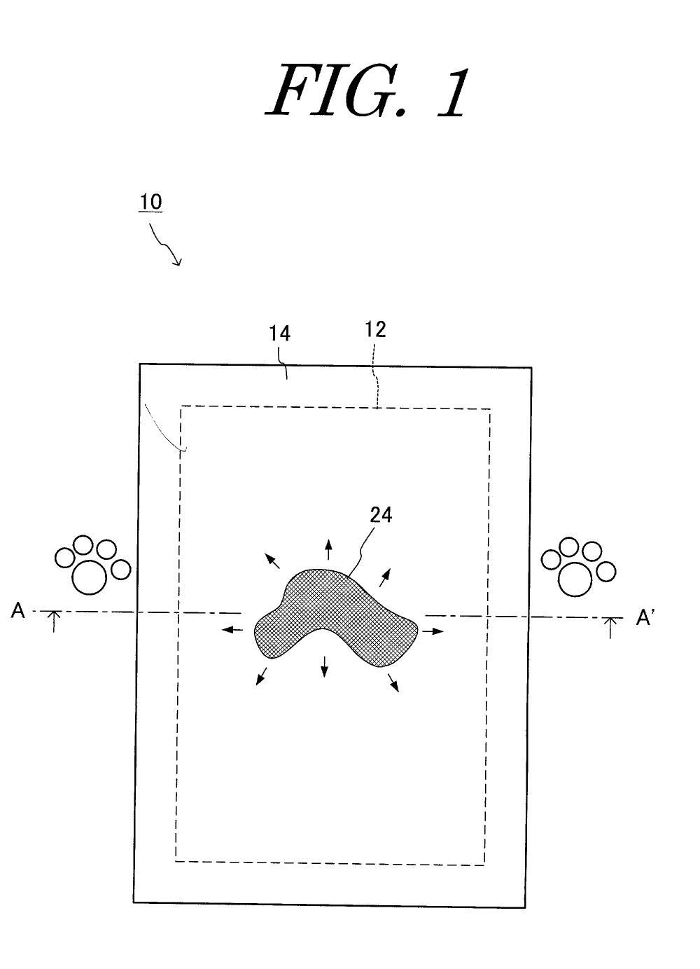

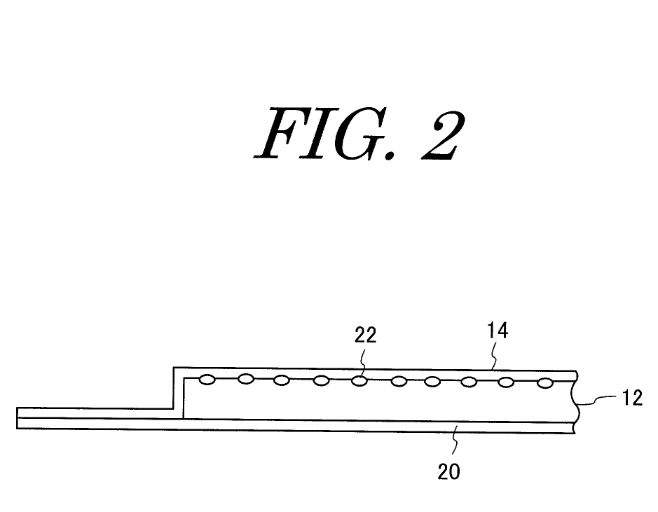

FIGS. 1 and 2 show a plan view and a sectional view of a pet sheet 10 according to the embodiment of the present invention, respectively. The pet sheet 10 includes an absorbent material (an absorbing material section) 12 having a good absorbing property to a liquid material such as urine, a hydrophilic top sheet 14 which is provided so as to cover the absorbent material 12, and a water-repellent or water-proofing back sheet 20 which is provided so as to, together with the top sheet 14, sandwich the absorbent material 12.

The absorbent material (i.e., the absorptive material section) 12 may be one made of a superabsorbent polymer (SPS) mixed with a pulp or cotton or provided together with a pulp or cotton in a layered structure and a tissue paper or non-woven fabric covering the SPS-pulp/cotton structure. The absorbent material 12 may be provided between the top sheet 14 and the back sheet 20 in the approximately center area, and serves to absorb and retain an excrement 24 (e.g., urine) discharged from a pet. The absorbent material 12 may be formed into a sheet having a surface area of 100 cm² or larger, for example.

The top sheet 14 may be a non-woven fabric consisting of synthetic fibers, such as a point-bonded non-woven fabric consisting of polypropylene (PP) fibers, a non-woven fabric containing absorbent fibers (e.g., rayon fibers) or a non-woven fabric consisting only of absorbent fibers. A microporous film having numerous micropores may also be used as the top sheet 14. The back sheet 20 may be a polyethylene (PE) film, a vinyl sheet or the like.

The materials used in the embodiment are as follows:

(1) Top sheet: PP point-bonded non-woven fabric 20 g/m²

(2) Absorbent material: cover tissue 20 g/m²

absorbent polymer 30 g/m²

carrier tissue 20 g/m²

pulp 150 g/m²

(3) Back sheet: PE film 20 g/m²

FIG. 2 shows the positions at which the solution of an amphoteric polymer having an acidic pH is added (for example, fixed or attached). The solution of an amphoteric polymer having an acidic pH (hereinafter, also referred to as the “polymer solution”) 22 is splayed onto the absorbent material 12 and the top sheet 14 is then placed thereon, so that the polymer solution 22 is exuded to the top sheet 14. Alternatively, the acidic polymer solution 22 may be sprayed directly onto the absorbent material 12 and the top sheet 14.

When the pet sheet 10 thus produced is used in the manner where the pet sheet 10 is laid on the floor or the like, a pet animal (e.g., a dog) discharges urine 24 or the like on the pet sheet 10 while tramping on or walking across the pet sheet 10. The discharged urine 24 is absorbed in the absorbent material 12 through the top sheet 14.

According to the embodiment, the urine 24 is retained by the absorbent material 12 and the top sheet 14 both to which the acidic polymer solution 22 is added. The obnoxious odors of alkaline substances such as ammonia and trimethylamine generated from the urine 24 cause neutralization reactions with the acidic functional groups of the polymer solution 22 to eliminate such odors. Alkaline substances (e.g., ammonia and trimethylamine) evaporated from the urine 24, which are obnoxious odors, are bound to the polymer solution 22 added onto the top sheet 14, where neutralization reactions occur to eliminate the odors. In addition to the odors caused by alkaline substances, urine may also generate odors caused by acidic substances such as fatty acids and sulfides to a small extent. The odors caused by acidic substances can also be eliminated by the neutralization of such acidic substances with the basic functional groups in the solution of an amphoteric polymer.

In addition, the acidic polymer solution 22 added onto the top sheet 14 contains a sulfone group, a carboxyl group and/or a phosphate group. Such a functional group serves as a surfactant so as to render the top sheet 14 hydrophilic. As a result, urine 24 can be absorbed into the pulp fibers quickly. For example, in a test using a physiological saline containing 0.1% ammonia (ammonia: 0.1%, NaCl: 0.9%, in water) as a sample urine, the absorption rate with the polymer solution 22 was 24 sec., while the absorption rate without the polymer solution 22 was 27 sec.

There has been described above a specific embodiment in accordance with the present invention. However, it will be appreciated that the invention is not limited thereto, and it is to be understood that modifications will be apparent to those skill in the art without departing from the spirit of the invention.

As described above, according to the present invention, excrements such as urine can be absorbed quickly and odors generated from urine or the like can be eliminated. That is, upon discharge of urine, the deodorization is achieved by the acidic polymer solution added onto the top sheet. On the other hand, the odor of ammonia gradually generated over time can be eliminated by the amphoteric polymer solution added onto the absorbent material. The use of a solution of an amphoteric polymer having an acidic pH makes it possible to eliminate acidic odors which may generate to a small extent. In addition, the absorbing efficiency to urine can be improved by the surfactant-like effect of the amphoteric polymer solution.

What is claimed is:

1. A pet sheet comprising:
an absorbent material having a good liquid-absorbing property;
a hydrophilic top sheet provided on the absorbent material; and
an acidic polymer solution which is added to the absorbent material and the top sheet.

2. A pet sheet according to claim 1, wherein
the acidic polymer solution is sprayed to the absorbent material.

3. A pet sheet according to claim 1, wherein
the acidic polymer solution is sprayed to the absorbent material and then the top sheet is placed on the absorbent material so that the acidic polymer solution is exuded from the absorbent material to the top sheet.

4. A pet sheet comprising:
an absorbent material having a good liquid-absorbing property;
a hydrophilic top sheet provided on the absorbent material; and
a solution of an amphoteric polymer having an acid pH being added to the absorbent material and the top sheet.

5. A pet sheet according to claim 4, wherein
the solution is sprayed to the absorbent material.

6. A pet sheet according to claim 4, wherein
the solution is sprayed to the absorbent material and then the top sheet is placed on the absorbent material so that the solution is exuded from the absorbent material to the top sheet.
